(19) United States
(12) Patent Application Publication
(10) Pub. No.: US 2007/0013821 A1
(43) Pub. Date: Jan. 18, 2007

(54) Liquid crystal display and method of manufacturing the same

(75) Inventors: Min-Sok Jang, Suwon-si (KR); Baek-Kyun Jeon, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/418,038

(22) Filed: May 4, 2006

(30) Foreign Application Priority Data
Jul. 12, 2005 (KR) 10-2005-0062722

(51) Int. Cl. G02F 1/1333

(52) U.S. Cl. 349/40

(57) ABSTRACT

A method for manufacturing a liquid crystal display comprises forming a surfactant on a first surface of a first substrate, and treating the first substrate. A liquid crystal display comprises an upper panel, a lower panel facing the upper panel and attached to the upper panel, a static electricity blocking layer formed on at least one surface of the upper and lower panels, and a polarizer attached on the static electricity blocking layer.

### CROSS-REFERENCE TO RELATED APPLICATION

This application claims priority to Korean Patent Application No. 10-2005-0062722 filed on Jul. 12, 2005, the content of which is incorporated by reference herein in its entirety.

### BACKGROUND OF THE INVENTION

(a) Technical Field

The present disclosure relates to a liquid crystal display and a method of manufacturing the same, and more particularly to a liquid crystal display and a method of manufacturing the same, wherein accumulated charges are discharged in the manufacturing process.

(b) Discussion of the Related Art

Liquid crystal displays (LCDs) are widely-used flat panel displays. An LCD comprises two panels including field-generating electrodes and a liquid crystal (LC) layer interposed between the two panels. The LCD displays images by applying voltages to the field-generating electrodes to generate an electric field in the LC layer, which determines orientations of LC molecules in the LC layer to adjust polarization of incident light.

In the LCDs, charges may be accumulated on the panels or thin films formed on the panel of the LCD. The accumulated charges may be discharged in an upward direction of the panel or to the outside along the surface of the panel.

If the accumulated charges are discharged in the inner portion of the LCD, electrostatic defects such as, for example, electrostatic ticks and electrostatic spots may be generated in the manufacturing process of the LCD. The electrostatic ticks may cause the channels of thin film transistors in pixels not to function due to momentary static electricity. Electrostatic spots are shown as vertical lines and horizontal lines on the gate lines and the data lines due to the momentary static electricity in the manufacturing process. Furthermore, dust and residue adhere to the accumulated charges on the surface of the panel, which may cause the driving voltage of the LCD to be abnormal. In large scale LCD panels, it is more difficult to discharge the accumulated charges. Thus, electrostatic defects can be more easily generated in manufacturing the large scale LCD panels.

### SUMMARY OF THE INVENTION

According to an embodiment of the present invention, a method for manufacturing a liquid crystal display includes forming a surfactant on a first surface of a first substrate, and treating the first substrate.

The surfactant may comprise a cationic surfactant, an anionic surfactant, or an amphoteric surfactant. The surfactant may be formed on the first surface by using a roller.

The method may further include cleaning a second surface of the first substrate before or after treating the first substrate, wherein the first surface is positioned opposite the second surface.

The surfactant may be formed on the surface by using a nozzle, and the first substrate may be cleaned after forming the surfactant. The spray pressure used to form the surfactant on the substrate may be smaller than a spray pressure used when washing the first substrate. The first substrate may be cleaned by using an organic solvent or deionized water.

The treatment of the first substrate may include the formation of a thin film on the second surface of the first substrate facing the first surface. The treatment of the first substrate may include the formation of an alignment layer on the second surface of the first substrate facing the first surface. The treatment of the first substrate may include the formation of an electric field generating electrode on a second surface of the first substrate facing the first surface. The treatment of the first substrate may include the formation of an alignment layer on the second surface of the first substrate facing the first surface and rubbing of the alignment layer.

The method may further include combining the first substrate and a second substrate facing the first substrate to manufacture a liquid crystal panel assembly, scribing the liquid crystal panel assembly, and polishing the scribed section of the liquid crystal panel assembly.

The treatment of the first substrate may include the attachment of a polarizer on the first surface of the first substrate.

According to an embodiment of the present invention, a liquid crystal display includes an upper panel, a lower panel facing the upper panel and attached to the upper panel, a static electricity blocking layer formed on at least one outer surface of the upper and lower panels, and a polarizer attached on the static electricity blocking layer. The static electricity blocking layer may include a cationic surfactant, an anionic surfactant, or an amphoteric surfactant.

### BRIEF DESCRIPTION OF THE DRAWINGS

Exemplary embodiments of the present invention can be understood in more detail from the following description taken in conjunction with the accompanying drawings in which:

FIG. 1 is a layout view of a liquid crystal display according to an embodiment of the present invention;

FIGS. 2 and 3 are sectional views of the LCD shown in FIG. 1, taken along the lines II-II and III-III, respectively;

FIGS. 4A to 4E are sectional views showing a method for manufacturing an LCD according to an embodiment of the present invention;

FIGS. 5A to 5D are sectional views showing a method for forming an alignment layer in an LCD according to an embodiment of the present invention;

FIGS. 6A and 6B are sectional views showing a method for scribing a panel in an LCD according to an embodiment of the present invention;

FIGS. 7A to 7D are sectional views showing a method for attaching a polarizer to panels in an LCD according to an embodiment of the present invention;

FIG. 8 is a photograph showing a conventional LCD charged by static electricity; and

FIG. 9 is a photograph showing an LCD charged by static electricity according to an embodiment of the present invention.

### DETAILED DESCRIPTION OF EXEMPLARY EMBODIMENTS

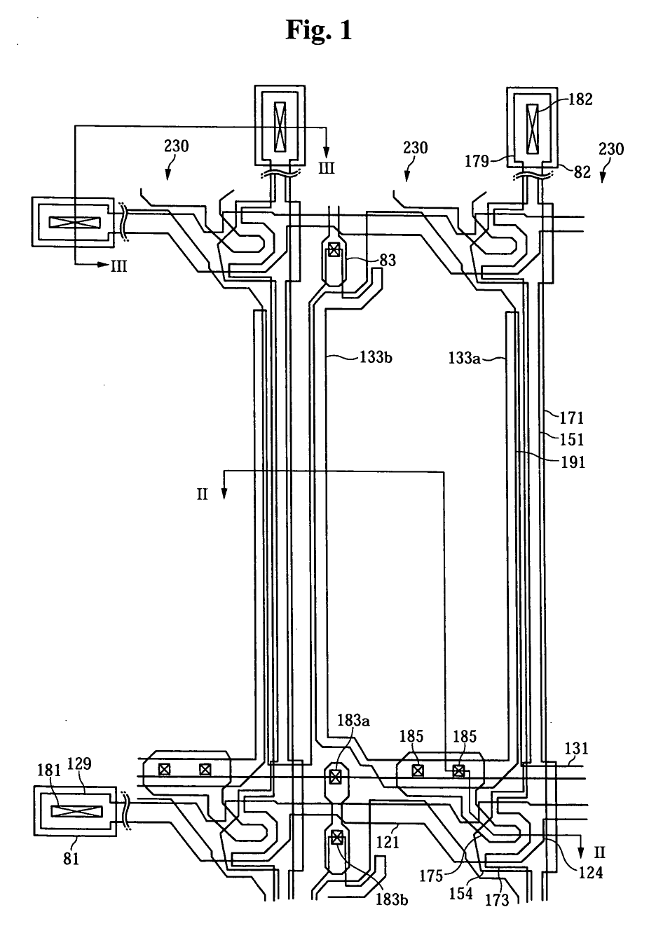

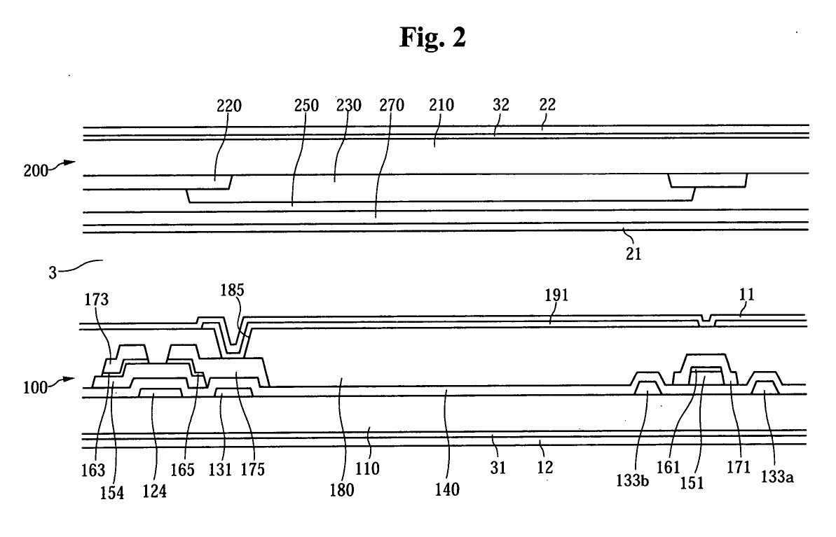

Exemplary embodiments of the present invention are more fully described below with reference to the accompanying drawings. The present invention may be embodied in many different forms and should not be construed as limited to the embodiments set forth herein. FIG. 1 is a layout view of a liquid crystal display according to an embodiment of the present invention. FIGS. 2 and 3 are sectional views of the LCD shown in FIG. 1, taken along the lines II-II and III-III, respectively.

Referring to FIGS. 1 to 3, a liquid crystal display according to an embodiment of the present invention comprises a lower panel 100, an upper panel 200 facing the lower panel 100, and a liquid crystal layer 3 formed between the upper and lower panels 100 and 200.

A plurality of gate lines 121 and a plurality of storage electrode lines 131 are formed on an insulating substrate 110 comprising a material such as, for example, transparent glass or plastic.

The gate lines 121 transmit gate signals and extend substantially in a transverse direction. Each of the gate lines 121 comprises a plurality of gate electrodes 124 projecting upward and an end portion 129 having an area large enough for contacting another layer or an external driving circuit. A gate driving circuit (not shown) for generating the gate signals may be mounted on a flexible printed circuit (FPC) film (not shown), which may be attached to the substrate 110, directly mounted on the substrate 110, or integrated onto the substrate 110. The gate lines 121 may extend to be connected to a driving circuit that may be integrated on the substrate 110.

The storage electrode lines 131 receive a predetermined voltage, and each of the storage electrode lines 131 comprises a stem extending substantially parallel to the gate lines 121, and a plurality of pairs of storage electrodes 133a and 133b branched from the stems. Each of the storage electrode lines 131 is disposed between two adjacent gate lines 121, and a stem is formed close to one of the two adjacent gate lines 121. Each of the storage electrodes 133a and 133b has a fixed end portion connected to the stem and a free end portion disposed opposite thereto. The fixed end portion of the storage electrode 133b has an area, and the free end portion thereof is bifurcated into a linear branch and a curved branch. According to an embodiment of the present invention, the storage electrode lines 131 may have various shapes and arrangements.

According to an embodiment of the present invention, the gate lines 121 and the storage electrode lines 131 comprise, for example, an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ta, or Ti. According to an embodiment of the present invention, the gate lines 121 and the storage electrode lines 131 may have a multi-layered structure including two conductive films (not shown) having different physical characteristics. One of the two films may comprise, for example, a low resistivity metal such as an Al-containing metal, a Ag-containing metal, and a Cu-containing metal for reducing a signal delay or a voltage drop. The other film comprises a material such as, for example, a Mo-containing metal, Cr, Ta, or Ti, which have good physical, chemical, and electrical contact characteristics with other materials such as, for example, indium tin oxide (ITO) or indium zinc oxide (IZO). Examples of the combination of the two films are a lower Cr film and an upper Al (alloy) film, and a lower Al (alloy) film and an upper Mo (alloy) film. According to alternate embodiments of the present invention, the gate lines 121 and the storage electrode lines 131 may comprise various metals or conductors.

The lateral sides of the gate lines 121 and the storage electrode lines 131 are inclined relative to a surface of the substrate 110 from about 30 degrees to about 80 degrees.

A gate insulating layer 140 comprising, for example, silicon nitride (SiNx) or silicon oxide (SiOx) is formed on the gate lines 121 and the storage electrode lines 131.

A plurality of semiconductor stripes 151 comprising, for example, hydrogenated amorphous silicon (“a-Si”) or polysilicon are formed on the gate insulating layer 140. The semiconductor stripes 151 extend substantially in the longitudinal direction and become wide near the gate lines 121 and the storage electrode lines 131 such that the semiconductor stripes 151 cover large areas of the gate lines 121 and the storage electrode lines 131. Each of the semiconductor stripes 151 comprises a plurality of projections 154 branched out toward the gate electrodes 124.

A plurality of ohmic contact stripes 161 and islands 165 are formed on the semiconductor stripes 151. The ohmic contact stripes 161 and islands 165 comprise, for example, silicide or n+ hydrogenated a-Si heavily doped with an N− type impurity such as phosphorous. Each ohmic contact stripe 161 comprises a plurality of projections 163. The projections 163 and the ohmic contact islands 165 are located in pairs on the projections 154 of the semiconductor stripes 151.

The lateral sides of the semiconductor stripes 151 and the ohmic contacts 161 and 165 are inclined relative to the surface of the substrate 110 from about 30 degrees to about 80 degrees.

A plurality of data lines 171 and a plurality of drain electrodes 175 are formed on the ohmic contact stripes 161 and the ohmic contact islands 165 and the gate insulating layer 140.

The data lines 171 transmit data signals and extend substantially in the longitudinal direction to intersect the gate lines 121. Each data line 171 intersects the storage electrode lines 131 and extends between adjacent pairs of storage electrodes 133a and 133b. Each data line 171 comprises a plurality of source electrodes 173 projecting toward the gate electrodes 124 and being curved like a crescent, and an end portion 179 having a large enough area for contacting another layer or an external driving circuit. A data driving circuit (not shown) for generating the data signals may be mounted on an FPC film (not shown), which may be attached to the substrate 110, directly mounted on the substrate 110, or integrated onto the substrate 110. The data lines 171 may extend to be connected to a driving circuit that may be integrated on the substrate 110.

The drain electrodes 175 are separated from the data lines 171 and disposed opposite the source electrodes 173 with respect to the gate electrodes 124. Each of the drain electrodes 175 comprises a wide end portion and a narrow end portion. The wide end portion overlaps a storage electrode line 131 and the narrow end portion is partially enclosed by a source electrode 173 with a “J” shape.

The gate electrode 124, the source electrode 173, and the drain electrode 175 along with the projection 154 of the semiconductor stripe 151 form a TFT having a channel formed in the projection 154 disposed between the source electrode 173 and the drain electrode 175.

The data lines 171 and the drain electrodes 175 comprise, for example, a refractory metal such as Cr, Mo, Ta, Ti, or alloys thereof. According to an embodiment of the present invention, the data lines 171 and the drain electrodes 175 may have a multilayered structure including a refractory metal film (not shown) and a low resistivity film (not shown). Examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. According to alternate embodiments of the present invention, the data lines 171 and the drain electrodes 175 may comprise various metals or conductors.

The data lines 171 and the drain electrodes 175 have inclined edge profiles, and the inclination angles thereof range about 30 degrees to about 80 degrees.

The ohmic contact stripes 161 and the ohmic contact islands 165 are interposed between the underlying semiconductor stripes 151 and the overlying data lines 171 and drain electrodes 175 thereon, and reduce the contact resistance therebetween. Although the semiconductor stripes 151 are narrower than the data lines 171 at most places, the width of the semiconductor stripes 151 becomes larger than the data lines 171 near the gate lines 121 and the storage electrode lines 131 to smooth the profile of the surface, thereby preventing disconnection of the data lines 171. The semiconductor stripes 151 have substantially the same planar shapes as the data lines 171 and the drain electrodes 175 as well as the underlying ohmic contact stripes 161 and islands 165. According to an embodiment of the present invention, the semiconductor stripes 151 may comprise some exposed portions, which are not covered with the data lines 171 and the drain electrodes 175, such as portions located between the source electrodes 173 and the drain electrodes 175.

A passivation layer 180 is formed on the data lines 171, the drain electrodes 175, and the exposed portions of the semiconductor stripes 151. The passivation layer 180 may comprise, for example, an inorganic or organic insulator. According to an embodiment of the present invention, the passivation layer 180 may have a flat top surface. Examples of the inorganic insulator include silicon nitride and silicon oxide. The organic insulator may have photosensitivity and a dielectric constant of less than about 4.0. The passivation layer 180 may comprise, for example, a lower film of an inorganic insulator and an upper film of an organic insulator to have excellent insulating characteristics of the organic insulator while preventing the exposed portions of the semiconductor stripes 151 from being damaged.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121, a plurality of contact holes 183a exposing portions of the storage electrode lines 131 near the fixed end portions of the storage electrodes 133b, and a plurality of contact holes 183b exposing the linear branches of the free end portions of the storage electrodes 133b.

A plurality of pixel electrodes 191, a plurality of overpasses 83, and a plurality of contact assistants 81 and 82 are formed on the passivation layer 180. The pixel electrodes 191, overpasses 83 and contact assistants 81, 82 comprise, for example, a transparent conductor such as ITO or IZO, or a reflective conductor such as Ag, Al, Cr, or alloys thereof.

The pixel electrodes 191 are physically and electrically connected to the drain electrodes 175 through the contact holes 185 such that the pixel electrodes 191 receive data voltages from the drain electrodes 175. The pixel electrodes 191 receive the data voltages and generate electric fields in cooperation with a common electrode 270 of the opposing upper panel (or, color filter panel) 200, which receive a common voltage. The electric fields determine the orientations of liquid crystal molecules (not shown) of the liquid crystal layer 3 disposed between the two panels 100 and 200. A pixel electrode 191 and the common electrode 270 form a capacitor referred to as a “liquid crystal capacitor,” which stores applied voltages after the TFT turns off.

A pixel electrode 191 overlaps a storage electrode line 131 including storage electrodes 133a and 133b. The pixel electrode 191 and a drain electrode 175 connected thereto and the storage electrode line 131 form an additional capacitor referred to as a “storage capacitor,” which enhances the voltage storing capacity of the liquid crystal capacitor.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and enhance the adhesion between the end portions 129 and 179, and external devices.

The overpasses 83 cross over the gate lines 121. The overpasses 83 are connected to the exposed portions of the storage electrode lines 131 and the exposed linear branches of the free end portions of the storage electrodes 133b through the contact holes 183a and 183b, respectively. The overpasses 83 and the contact holes 183a and 183b are disposed opposite to each other with respect to the gate lines 121. The storage electrode lines 131 including the storage electrodes 133a and 133b along with the overpasses 83 can be used for repairing defects in the gate lines 121, the data lines 171, or the TFTs.

A light blocking member 220 referred to as a black matrix for preventing light leakage is formed on an insulating substrate 210 comprising a material such as, for example, transparent glass or plastic. The light blocking member 220 may have a plurality of openings that face the pixel electrodes 191, and may have substantially the same planar shape as the pixel electrodes 191.

A plurality of color filters 230 are formed on the insulating substrate 210, and disposed substantially in the areas enclosed by the light blocking member 220. The color filters 230 may extend substantially in the longitudinal direction along the pixel electrodes 191. The color filters 230 may include one of the primary colors such as red, green, and blue.

An overcoat 250 is formed on the color filters 230 and the light blocking member 220. The overcoat 250 may comprise, for example, an organic insulator. The overcoat 250 prevents the color filters 230 from being exposed and provides a flat surface. According to an embodiment of the present invention, the overcoat 250 may be omitted.

The common electrode 270 is formed on the overcoat 250. The common electrode 270 may comprise, for example, a transparent conductive material such as ITO and IZO. In an embodiment, the common electrode 270 may be provided in the thin film transistor array panel 100.

Inorganic alignment layers 11 and 21 are formed on inner surfaces of the panels 100 and 200, and polarizers (not shown) are formed on outer surfaces of the panels 100 and 200 so that their polarization axes may cross. One of the polarization axes may be parallel to the gate lines 121.

Static electricity blocking layer 31 and 32 are formed on outer surfaces of the lower and upper panels 100 and 200. Polarizers 12 and 22 are provided on outer surfaces of the static electricity blocking layers 31 and 32 so that their polarization axes may be crossed. One of the polarization axes may be parallel to the gate lines 121. According to an embodiment of the present invention, one of the polarizers 12 and 22 may be omitted when the LCD is a reflective type LCD. For example, the static electricity blocking layers 31 and 32 prevent the static electricity from being generated when removing protection films (not shown) covering the polarizers 12 and 22. The static electricity blocking layers 31 and 32 may comprise, for example, a cationic surfactant, an anionic surfactant, or an amphoteric surfactant.

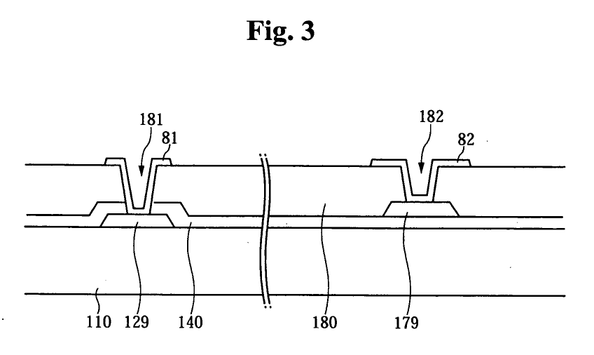

A method for manufacturing an LCD according to an embodiment of the present invention is described with reference to FIGS. 4A to 7D.

FIGS. 4A to 4E are sectional views showing a method of manufacturing an LCD according to an embodiment of the present invention. The method includes, for example, a step of forming a thin film.

Referring to FIGS. 4A and 4B, a surfactant 31 is formed on a first surface 110p of the insulating substrate 110, and a second surface 110q of the insulating substrate 110 is cleaned. The cleaning process may be performed using a cleaning nozzle 52 connected to a cleaning device 51, and the material sprayed by the cleaning nozzle 52 may be, for example, a liquid material such as an organic solvent or deionized water.

The surfactant 31 may be formed on the first surface 110p by using, for example, a roller 41 as shown in FIG. 4B, or a nozzle 43 connected to a surfactant supply 42 to spray the surfactant as shown in FIG. 4C. The surfactant 31 is formed on the first surface 110p of the insulating substrate 110, and then the second surface 110q of the insulating substrate 110 is cleaned to prevent the surfactant from remaining on the second surface 110q of the insulating substrate 110. According to an embodiment of the present invention, the spray process of the surfactant 31 and the cleaning process of the insulating substrate 110 may be simultaneously performed. According to an embodiment of the present invention, the spray pressure used to clean the second surface 110q is greater than the spray pressure used to form the surfactant 31 on the first surface 110p to prevent the surfactant from remaining on the second surface 110q of the insulating substrate 110.

The surfactant 31 may comprise, for example, an anionic surfactant such as soap and alkyl benzene sulfonate (ABS), a cationic surfactant such as a higher amine halide, a quaternary ammonium salt, alkyl pyridinium salt, or an amphoteric surfactant such as an amino acid.

Referring to FIG. 4E, a thin film 61 is deposited on the second surface 110q of the substrate 110.

According to an embodiment of the present invention, the thin film 61 may comprise thin film transistors, the color filters 230, the pixel electrodes 191, or the common electrode 270 as shown in FIGS. 1 to 3.

The surfactant 31 is formed on the surface 110p facing the second surface 110q on which the thin film 61 is formed, and then the surfactant 31 is ionized by reacting with the moisture of the air. Therefore, the remaining charges of the substrates 110 and 210 moving along the surfaces of the substrates 110 and 210 using cations and anions as hopping sites are discharged to the outside of the substrates 110 and 210. Accordingly, the defects due to the static electricity may be prevented in the manufacturing process for forming the thin film transistors, the color filters 230, the pixel electrodes 191, or the common electrode 270.

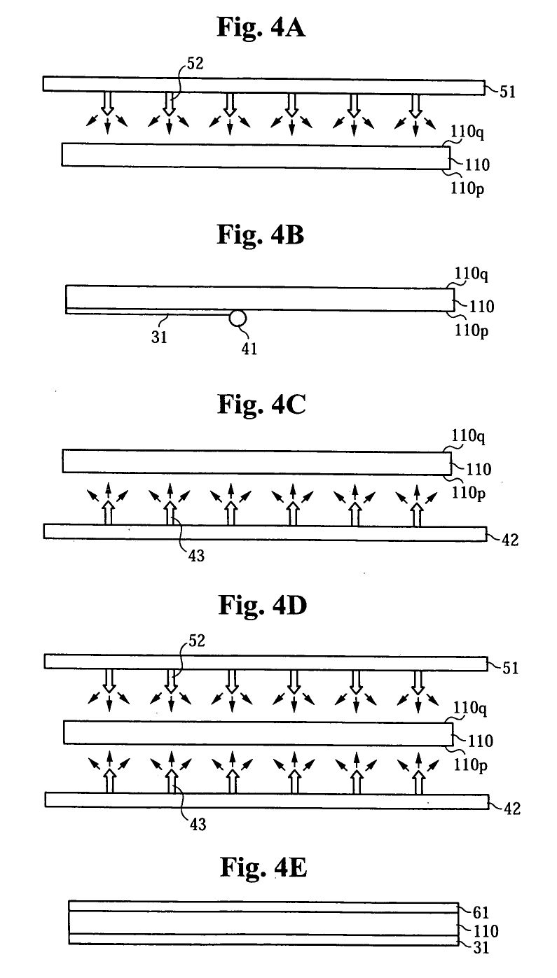

FIGS. 5A to 5D are sectional views showing a method of forming a part of an LCD such as an alignment layer according to an embodiment of the present invention.

Referring to FIG. 5A, a thin film 61 including field-generating electrodes such as the common electrode 270 and the pixel electrode 190 is cleaned, and the surfactant 31 is formed on the first surface 110p of the insulating substrate 110. In FIG. 5A, the spray process of the surfactant 31 and the cleansing process of the thin film 61 are simultaneously performed. Alternatively, the spray process and the cleaning process may be separately performed as shown in FIGS. 4A to 4C.

Referring to FIG. 5B, the alignment layer 11 is formed on the cleaned thin film 61. The alignment layer 11 may comprise, for example, an organic alignment layer such as polyimide.

Referring to FIG. 5C, the alignment layer 11 is rubbed by using, for example, a rubbing roller 44 with a uniform force, velocity, and direction.

Referring to FIG. 5D, the surface of the alignment layer 11 is cleaned to remove contaminants caused by the rubbing roller 44. The surfactant 31 is formed on the first surface 110p of the insulating substrate 110. The spray process of the surfactant and the cleansing process may be separately performed as shown in FIGS. 4A to 4C. Defects due to the static electricity may be prevented in the manufacturing process for forming the alignment layer 11 by forming the surfactant on the surface facing the second surface on which the thin film 61 is formed.

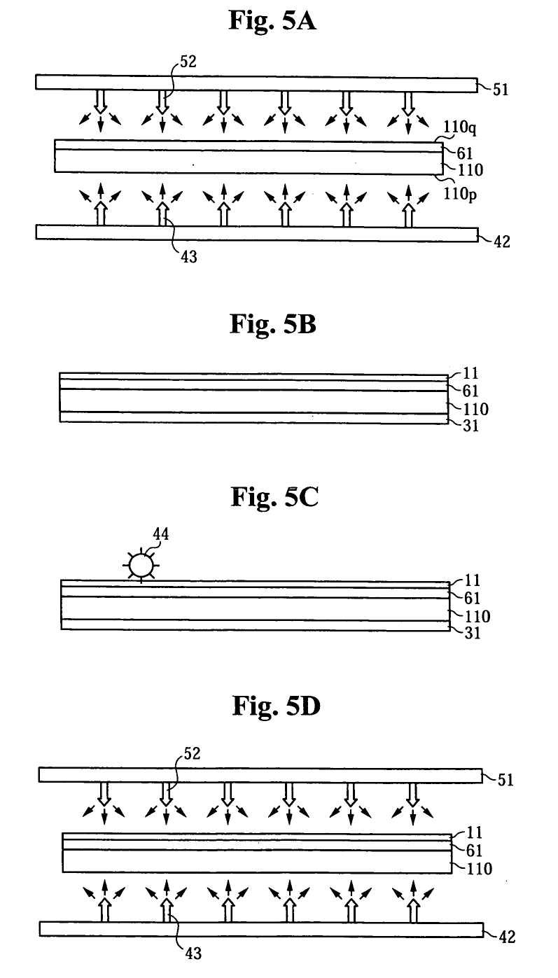

FIGS. 6A and 6B are sectional views showing a method for scribing a panel according to an embodiment of the present invention.

Referring to FIGS. 6A and 6B, the upper panel 200 and the lower panel 100 are combined to form a liquid crystal panel assembly after an alignment process, and the liquid crystal panel assembly is scribed for dividing it into unit display devices of a predetermined size. The scribing sections are polished. The spray process of the surfactant and the cleaning process of the liquid crystal panel assembly are simultaneously or separately performed. Accordingly, the defects due to the static electricity may be prevented in the manufacturing process for forming the liquid crystal panel assembly.

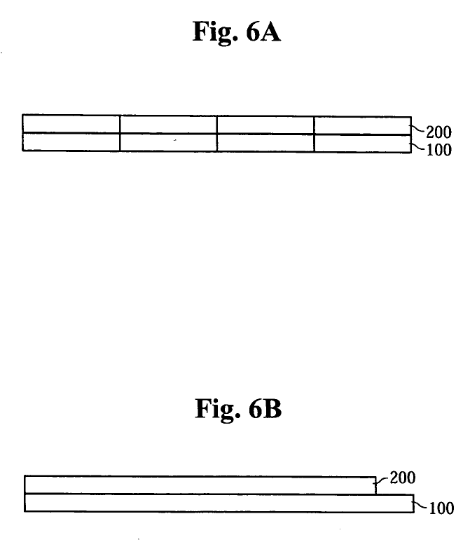

FIGS. 7A to 7D are sectional views showing a method for attaching a polarizer to the lower and upper panels 100, 200 according to an embodiment of the present invention.

Referring FIGS. 7A-7D, the liquid crystal panel assembly including the upper panel 200 and the lower panel 100 is cleaned by using a cleaning device 51, and then surfactants 31 and 32 are formed on the upper and lower surfaces of the liquid crystal panel assembly. The surfactant 31 may be formed on the first surface 110p by using the nozzle 43 connected to a surfactant supply 42, or by using a roller 41 as shown in FIG. 4B. Polarizers 12 and 22 on which protection films 13 and 23 are respectively attached are respectively attached over the surfactants 31 and 32. Then, the protection films 13 and 23 are respectively removed from the polarizers 12 and 22 to complete the liquid crystal display as shown in FIG. 2. Thus, if the surfactants 31 and 32 are formed on the surfaces of the liquid crystal panel assembly, the defects due to the static electricity that may occur when removing the protection films 13, 23 can be prevented. Accordingly, a conductive plate attached to the polarizer 12 and 22 may be omitted according to an embodiment of the present invention.

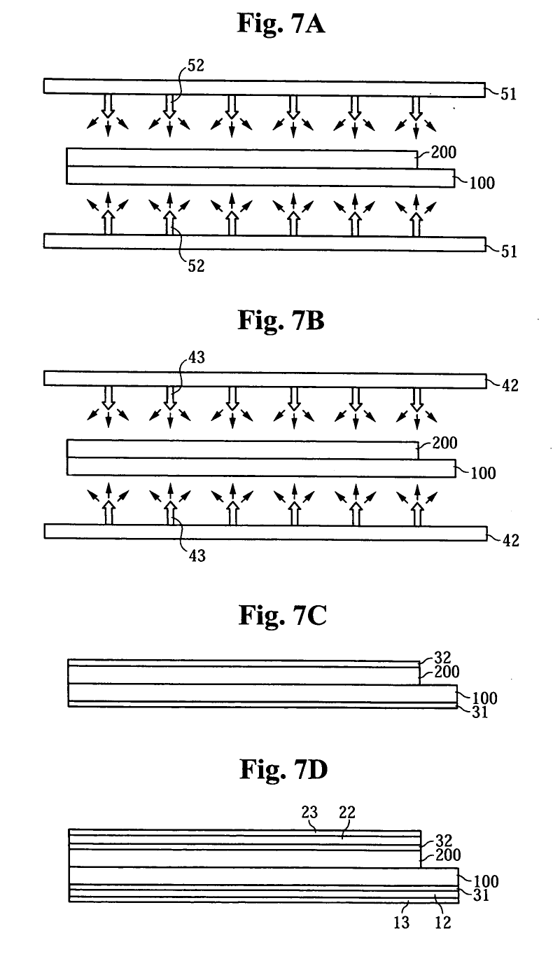

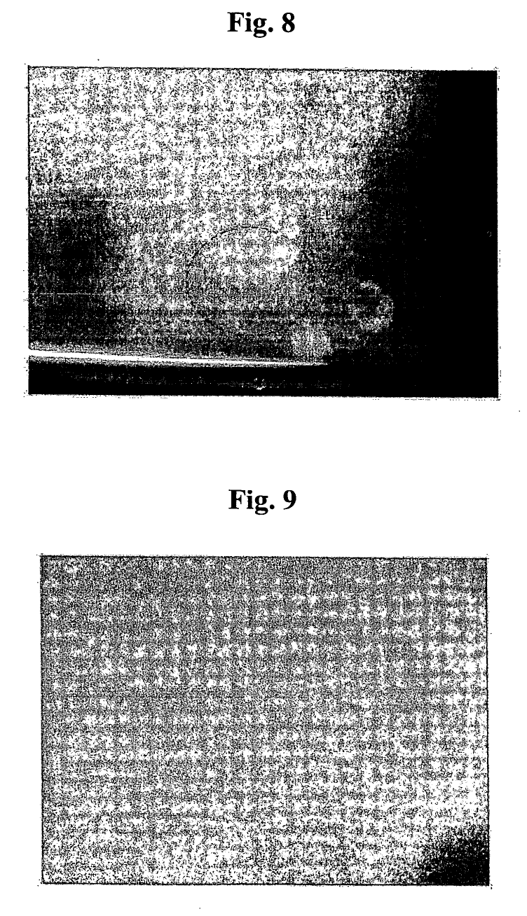

A protection effect against the static electricity of a liquid crystal display according to an embodiment of the present invention is described with reference to FIGS. 8 and 9.

FIG. 8 is a photograph showing an LCD without a surfactant charged by the static electricity of 10 kV. FIG. 9 is a photograph showing an LCD charged by the static electricity of 10 kV and including a surfactant according to an embodiment of the present invention.

In FIG. 8, spots due to the static electricity appear in and near the circle with dotted lines. Minimal or no spots are shown in FIG. 9.

Accordingly, the liquid crystal display of FIG. 9 has good display quality in comparison with the liquid crystal display of FIG. 8.

As above-described, the static electricity charges may be discharged in manufacturing the liquid crystal display according to an embodiment of the present invention such that the defects due to the static electricity may be prevented.

Although the exemplary embodiments of the present invention have been described with reference to the accompanying drawings, it is to be understood that the present invention should not be limited these precise embodiments but various changes and modifications can be made by one ordinary skill in the art without departing from the spirit and scope of the present invention. All such changes and modifications are intended to be included with the scope of the invention as defined by the appended claims.

What is claimed is:

1. A method for manufacturing a liquid crystal display, comprising:
forming a surfactant on a first surface of a first substrate; and
treating the first substrate.

2. The method of claim 1, wherein the surfactant comprises a cationic surfactant, an anionic surfactant, or an amphoteric surfactant.

3. The method of claim 1, wherein the surfactant is formed on the first surface by using a roller.

4. The method of claim 1, further comprising:
cleaning a second surface of the first substrate before or after treating the first substrate, wherein the first surface is positioned opposite the second surface.

5. The method of claim 4, wherein the surfactant is formed on the first surface by using a nozzle, and the first substrate is cleaned after forming the surfactant on the first surface.

6. The method of claim 4, wherein the surfactant is formed on the first surface by using a nozzle, and a spray pressure used to form the surfactant on the first surface is smaller than a spray pressure used when cleaning the first substrate.

7. The method of claim 4, wherein the first substrate is cleaned by using an organic solvent or deionized water.

8. The method of claim 1, wherein treating the first substrate comprises forming a thin film on a second surface of the first substrate, wherein the second surface is positioned opposite the first surface.

9. The method of claim 1, wherein treating the first substrate comprises forming an alignment layer on a second surface of the first substrate, wherein the second surface is positioned opposite the first surface.

10. The method of claim 1, wherein treating the first substrate comprises forming an electric field generating electrode on a second surface of the first substrate, wherein the second surface is positioned opposite the first surface.

11. The method of claim 1, wherein treating the first substrate comprises forming an alignment layer on a second surface of the first substrate, and rubbing of the alignment layer, wherein the second surface is positioned opposite the first surface.

12. The method of claim 1, further comprising:
combining the first substrate and a second substrate to manufacture a liquid crystal panel assembly, wherein the first substrate is positioned opposite the second substrate;
scribing the liquid crystal panel assembly; and
polishing the scribed section of the liquid crystal panel assembly.

13. The method of claim 1, wherein treating the first substrate comprises attaching a polarizer on the first surface of the first substrate.

14. A liquid crystal display, comprising:
an upper panel;
a lower panel facing the upper panel and attached to the upper panel;
a static electricity blocking layer formed on at least one surface of the upper and lower panels; and
a polarizer attached on the static electricity blocking layer.

15. The liquid crystal display of claim 14, wherein the static electricity blocking layer comprises a cationic surfactant, an anionic surfactant, or an amphoteric surfactant.

16. The liquid crystal display of claim 14, wherein the static electricity blocking layer is formed on an outer surface of the upper and lower panels.
